(19) United States
(12) Patent Application Publication
(10) Pub. No.: US 2008/0081574 A1
(43) Pub. Date: Apr. 3, 2008

(54) Embedded antenna

(76) Inventors: Kai Shih, Tu-Cheng City (TW); Yu-Yuan Wu, Tu-Cheng City (TW); Hung-Jen Chen, Tu-Cheng City (TW); Lan-Yung Hsiao, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/528,506

(22) Filed: Sep. 28, 2006

(51) Int. Cl. H04B 1/18

(52) U.S. Cl. 455/187.1

(57) ABSTRACT

An embedded antenna used in mobile phone includes a lower and a higher frequency portions connecting with the lower frequency portion via a first connecting portion. The lower frequency portion is a bended structure in planar inverted F antenna (PIFA) shape. The higher frequency portion is a loop antenna working in two different higher frequencies, including a first higher frequency portion and a second higher frequency portion connecting with the first one via a second connecting portion. The first connecting portion defines a feeding portion and a grounding portion. The second higher frequency portion defines another grounding portion. An electric current is formed between the first and the second higher frequency portions and can heighten the gain and the frequency band of the antenna. Additionally, a loudspeaker is disposed in a receiving space formed between the lower and higher frequency portions to save space with lowest influence to the antenna.

### BACKGROUND OF THE INVENTION

1. Field of the Invention

The present invention relates to an embedded antenna, and particularly to an antenna used inside mobile phone.

2. Related Art

As the development of modern mobile communication industry, mobile phones are designed more and more smaller with beautiful appearance. Nowadays the antenna outside mobile phone is changed to be inside. In certain cases, the antenna in planar shape is utilized to decrease the space occupied by the antenna. Because of smaller size and simple structure, a conventional planar inverted F antenna (PIFA) is ordinarily and commonly used in mobile phone and other mobile communication devices.

However, because of the limitation caused by the structure of itself such conventional planar inverted F antenna may only work in one or two frequencies. The conventional planar inverted F antenna is difficult to expand to a third one that is more and more required in mobile phones, particularly since the deployed second frequency is sometimes imperfect at response. Besides, while such conventional planar inverted F antenna is used inside the mobile phone, it may be interfered by the loudspeaker and is usually designed far away from the loudspeaker. Thus causes a waste of the precious space in mobile phone.

### SUMMARY OF THE INVENTION

Accordingly, an object of the present invention is to provide an embedded antenna used in mobile phone working in three different frequencies with perfect gain and frequency band. Simultaneously, such antenna saves the space occupied by the loudspeaker and restrains the interference caused by the loudspeaker. The antenna includes a lower and a higher frequency portions connecting with the lower frequency portion via a first connecting portion. The lower frequency portion is a bended structure in planar inverted F antenna (PIFA) shape. The higher frequency portion is a loop antenna working in two different higher frequencies, including a first higher frequency portion and a second higher frequency portion connecting with the first one via a second connecting portion. The first connecting portion defines a feeding portion and a grounding portion. The second higher frequency portion defines another grounding portion. An electric current is formed between the first and the second higher frequency portions and can heighten the gain and the frequency band of the antenna. Additionally, a loudspeaker is disposed in a receiving space formed between the lower and higher frequency portions to save space with lowest influence to the performance of the antenna.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of an antenna according to present invention; and

FIG. 2 is a perspective view of an antenna according to present invention assembled with a loudspeaker.

### DETAILED DESCRIPTION OF THE PREFERRED EMBODIMENTS

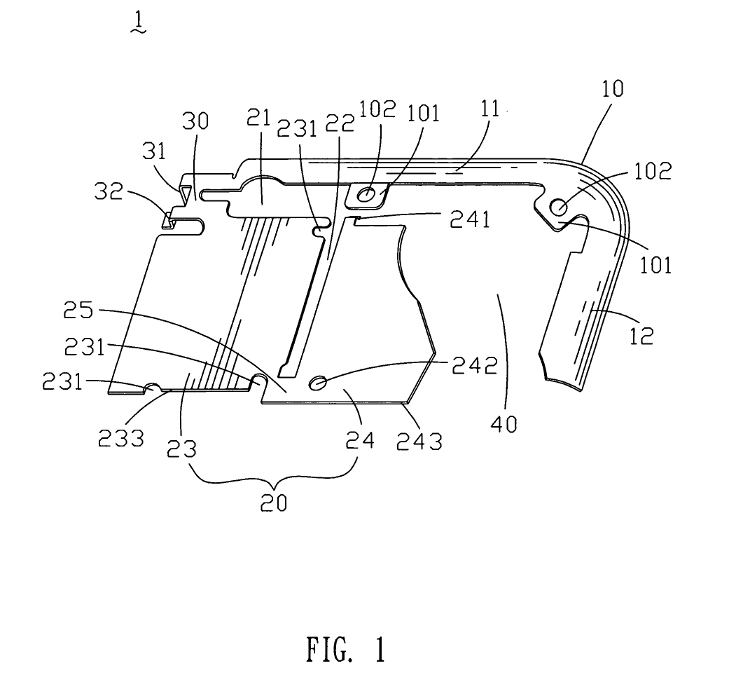

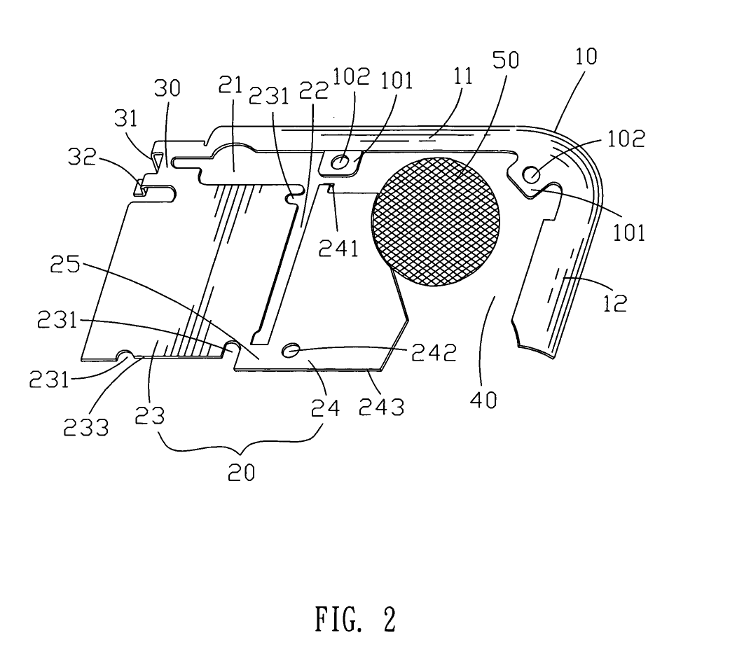

The antenna, shown in FIGS. 1-2, according to the preferred embodiment of the present invention provides the functional arrangement and formation to heighten the gain and the frequency band of the antenna, and simultaneously to save space with lowest influence to the performance of the antenna.

Referring to FIG. 1, the antenna I includes a lower frequency portion 10, a higher frequency portion 20 and a first connecting portion 30 connecting the lower and higher frequency portions 10, 20.

The lower frequency portion 10 is a bended structure in planar inverted F antenna (PIFA) shape, including a first side plate 11 in long narrow strip or piece. The first side plate 11 is bent backwardly from the right end to form a second side plate 12 also in long narrow strip or piece approximately perpendicular to the first side plate 11. The first side plate 11 stretches backwardly from the mid to form a flake 101 in square shape. And another flake 101 with the same structure is formed in the connecting portion of the first and second side plates 11, 12. Each flake 101 defines a fixing hole 102 in the mid portion of itself for being fixed in a mobile phone (not shown). The equivalent length of the lower frequency portion 10 matches with a quarter of the wavelength of the electromagnetic wave that the lower frequency portion 10 works in. This means that the lower frequency portion 10 may be suitable for global system of mobile communication (GSM) and work in 900 MHz.

The higher frequency portion 20 is a loop antenna structure suitable for two communication system DCS/PCS and respectively working in two different higher frequencies 1800/1900 MHz, including a first higher frequency portion 23 on the left and a second higher frequency portion 24 on the right. A second connecting portion 25 is defined on the back portion of the higher frequency portion 20 connecting the first and the second higher frequency portions 23, 24. And a long and narrow gap 22 is formed between the first and the second higher frequency portions 23, 24 located in front of the second connecting portion 25. While the width of the gap is changed, the antenna specification may be adjusted.

The first higher frequency portion 23 is approximately in rectangular figure and defines a plurality of fixing indentations 231 on the edge for being fixed in the mobile phone.

The front edge and back edge 243 of the second higher frequency portion 24 parallels with each other. And the back edge 243 of the second higher frequency portion 24 locates behind the back edge 233 of the first higher frequency portion 23. The second higher frequency portion 24 stretches downwardly from the front edge to form a second grounding portion 241 approximately in L shape with a height. While the height of the second grounding portion 241 is changed, the antenna specification may be adjusted. The second higher frequency portion 24 defines a fixing hole 242 in the back portion and near the second connecting portion 25 for being fixed in the mobile phone.

Alternatively, the present invention should not be regarded as limited to the particular location of the fixing hole 102, 242 and the fixing indentations 231 that are shown and described above, and may be formed in any other convenient portions of the antenna 1 and any other shapes on condition that can be fixed in the mobile phone, as would be obvious to persons having ordinary skill in the art after having become familiar with the teaching of the present invention.

As shown in FIG. 1, a receiving space for a loudspeaker 50 (as shown in FIG. 2) is formed on the right of the second higher frequency portion 24 located between the second higher frequency portion 24 and the first and second side plates 11, 12 of the lower frequency portion 10 to receive the loudspeaker 50. Correspondingly, the second higher frequency portion 24 is concave in the front portion of the right edge matching with the shape of the loudspeaker 50. However, the right edge of the second higher frequency portion 24 is not only limited to concave shape, and may be any other shape in condition that it matches with the shape of the loudspeaker 50. The second higher frequency portion 24 protrudes to the right to form an obtuse angle from the back portion of the right edge.

Referring to FIG. 1 again, the first connecting portion 30 connects the left end of the lower frequency portion 10 and the front edge of the first higher frequency portion 23. The front portion of the first connecting portion 30 defines a first grounding portion 31 in L shape stretching downwardly with a height and then being bent left. The back portion of the first connecting portion 30 defines a feeding portion 32 also in L shape stretching downwardly with a height and then being bent left. While the height of the first grounding portion 31 and the feeding portion 32, the antenna specification may be adjusted. An opening 21, for adjusting antenna specification, is formed in U shape on right of the first connecting portion 30 located between the first side plate 11 of the lower frequency portion 10 and the first higher frequency portion 23. While adjusting the width of the opening 21, the properties of the antenna 1 may be changed.

The first and second grounding portion 31, 241 and the feeding portion 32 described above respectively and electrically connect with a printed circuit board (PCB, not shown) of the mobile phone. While the antenna is at work, an electric current (not shown) may be formed between the feeding portion 32 and the second grounding portion 241 to increase the gain of the antenna 1 and broaden the frequency band the higher frequency portion 20 worked in.

As described above, via the connecting of the lower and higher frequency portions 10, 20, the antenna 1 may suitable for three communication systems GSM/DCS/PCS and respectively work in three different frequencies 900/1800/1900 MHz. And via the second connecting portion 25 connecting the first and second higher frequency portions 23, 24, an electric current is formed between the first and the second higher frequency portions 23, 24 to heighten the gain and the frequency band of the antenna. Additionally, the loudspeaker 50 is disposed in the receiving space 40 formed between the lower and the second higher frequency portions 10, 24 to save space with lowest influence to the performance of the antenna.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An antenna used inside mobile phone, comprising:
a lower frequency portion;
a higher frequency portion of loop antenna structure, working in two different higher frequencies; and
a first connecting portion defining a grounding portion and a feeding portion, connecting the lower and higher frequency portions,
wherein
said higher frequency portion comprises a first higher frequency portion and a second higher frequency portion connecting with said first higher frequency portion via a second connecting portion,
said second higher frequency portion defines a second grounding portion, and
a receiving space is formed between said second higher frequency portion and the lower frequency portion for receiving a loudspeaker herein.

2. The antenna clamed as in clam 1, wherein said second connecting portion connects a back portion of said first and second higher frequency portions; a long and narrow gap is formed between said first and second higher frequency portions in front of said second connecting portion for adjusting the antenna specification; and said second grounding portion is formed in the front of said second higher frequency portion.

3. The antenna clamed as in clam 1, wherein said lower frequency portion is in planar inverted F antenna shape, comprising a first side plate, and a second side plate stretching backwardly from one end of the first side plate.

4. The antenna clamed as in clam 3, wherein said higher frequency portion is located behind said first side plate of said lower frequency portion; and an opening in U shape is formed on right of said first connecting portion located between said first side plate and said first higher frequency portion.

5. The antenna clamed as in clam 3, wherein said receiving space is formed between said first and second side plate and said second higher frequency portion.

6. The antenna as claimed in claim 5, wherein a front portion of a right edge of said second higher frequency portion is in concave shape matching with a shape of said loudspeaker; and a back portion of said right edge of said second higher frequency portion protrudes to the right to form an obtuse angle.

7. The antenna as claimed in claim 1, wherein the equivalent length of said lower frequency portion matches with a quarter of the wavelength of the electromagnetic wave that the lower frequency portion works in; and said lower frequency portion is suitable for GSM system and works in 900 MHz.

8. The antenna as claimed in claim 1, wherein the higher frequency portion is suitable for DCS/PCS system and works in 1800/1900 MHz.

9. An antenna used inside mobile phone, comprising:
a lower frequency portion;
a higher frequency portion of loop antenna structure, working in two different higher frequencies; and
a first connecting portion defining a grounding portion and a feeding portion in L shape with a height for adjusting the antenna specification, wherein
said higher frequency portion comprises a first higher frequency portion and a second higher frequency portion,
said first connecting portion connecting said lower frequency portion and said first higher frequency portion and located therebetween, said first higher frequency portion defining an opening of U shape on the right thereof for adjusting antenna specification,
between said second higher frequency portion and said lower frequency portion, said second higher frequency portion defines a second grounding portion in L shape with a height for adjusting the antenna specification,
a second connecting portion connecting said first and second higher frequency portions,
a receiving space formed between said second higher frequency portion and the lower frequency portion for receiving a loudspeaker herein.

10. The antenna clamed as in clam 9, wherein said second connecting portion connects a back portion of said first and second higher frequency portions; a long and narrow gap is formed between said first and second higher frequency portions in front of said second connecting portion for adjusting the antenna specification; and said second grounding portion is formed in the front of said second higher frequency portion.

11. The antenna clamed as in clam 9, wherein said lower frequency portion is in planar inverted F antenna shape, comprising a first side plate, and a second side plate stretching backwardly from one end of the first side plate.

12. The antenna clamed as in clam 11, wherein said higher frequency portion located behind said first side plate of said lower frequency portion; and said opening in U shape is formed on right of said first connecting portion located between said first side plate and said first higher frequency portion.

13. The antenna clamed as in clam 11, wherein said receiving space is formed between said first and second side plate and said second higher frequency portion.

14. The antenna as claimed in claim 13, wherein a front portion of a right edge of said second higher frequency portion is in concave shape matching with a shape of said loudspeaker; and a back portion of said right edge of said second higher frequency portion protrudes to the right to form an obtuse angle.

15. The antenna as claimed in claim 9, wherein the equivalent length of said lower frequency portion matches with a quarter of the wavelength of the electromagnetic wave that the lower frequency portion works in; and said lower frequency portion is suitable for GSM system and works in 900 MHz.

16. The antenna as claimed in claim 9, wherein the higher frequency portion is suitable for DCS/PCS system and works in 1800/1900 MHz.
